(19) United States
(12) Patent Application Publication
(10) Pub. No.: US 2021/0344498 A1
(43) Pub. Date: Nov. 4, 2021

(54) SYSTEM, METHOD, AND COMPUTER PROGRAM FOR SECURE AUTHENTICATION OF LIVE VIDEO

(71) Applicant: Shonin Inc., Mississauga (CA)

(72) Inventor: Sergey PERUNOV, Maple (CA)

(21) Appl. No.: 17/271,095

(22) PCT Filed: Aug. 19, 2019
(86) PCT No.: PCT/CA2019/051125

§ 371 Date: Feb. 24, 2021

Related U.S. Application Data
(60) Provisional application No. 62/722,360, filed on Aug. 24, 2018.

(51) Int. Cl. H04L 9/32; H04L 9/06; H04L 29/06

(52) U.S. Cl. CPC H04L 9/3236; H04L 2209/38; H04L 63/08; H04L 9/0637

(57) ABSTRACT

There is provided a system, method, and computer program for securely authenticating a copy of a live video feed. This can include publishing cryptographic hashes of incremental chunks of video data from a live video feed to a smart contract based blockchain network. One example use is where the video has been shared and the user wants to validate that it has not been tampered with. In one aspect, the method can further include comparing cryptographic hashes of the shared copy to those of the original retrieved from the blockchain network.

### TECHNICAL FIELD

The following relates generally to secure authentication of live video, and more particularly, to the systems, methods, and computer programs for time-independent decentralized authentication of live video.

### BACKGROUND

Currently, deep fakes (in which one can “replace” a person's face in a video with someone else's face), which may rely on artificial intelligence (AI), can be used in video editing. Software that enables deep fakes will be more and more accessible to the average person. For the average security camera company, it would be reasonable for people to doubt the authenticity of the video being recorded the longer it has been in existence. Some attempted solutions have tried using a smart contract to securely authenticate a recording file from initial collection through post-production, but this has not sufficiently addressed the needs of the industry. There is a need for a system that allows for authentication of live video that reduces or eliminates the possibility that video authenticity may be compromised in copies of the live video. There is also a need for such a system to guarantee retrieval of data needed to authenticate the video at a later date in such a manner that provides confidence in the authenticity of the video. However, there can be various challenges and implementation problems with currently available alternatives, and they may not address these aforementioned needs.

### SUMMARY

There is provided a system and method for secure authentication of live video.

In an aspect, a method for creating a verifiable record of live video data chunk cryptographic hashes from a live video feed is provided, the method comprising: generating a first video data chunk from the live video feed, the first video data chunk comprising first video data, a first video length, and a first timestamp; calculating a first cryptographic hash of the first video data chunk; calculating a first time period from the first video length and the first timestamp; connecting to a blockchain network; generating a second video data chunk from the live video feed; calculating a second cryptographic hash of the second video data chunk; publishing the first cryptographic hash and the first time period with an associated payment token to the blockchain network after the generating a second video data chunk from the live video feed has started but before the calculating a second cryptographic hash of the second video data chunk has finished.

In an aspect, a method for securely authenticating a copy of a live video feed from a record of live video data chunk cryptographic hashes stored on a blockchain network, wherein the record of live video data chunk cryptographic hashes comprises a plurality of original cryptographic hashes and associated original time periods, is provided, the method comprising: generating a plurality of copy video data chunks from the copy of the live video feed, each of the copy video data chunks comprising copy video data, a copy video length, and a copy timestamp; for each of the copy video data chunks, calculating copy cryptographic hashes; for each of the copy video data chunks, calculating an associated copy time period from the copy video length and the copy timestamp; retrieving from the blockchain network each of the original cryptographic hashes; comparing each of the copy cryptographic hashes to each of the original cryptographic hashes and recording when each of the copy cryptographic hashes is identical to each of the original cryptographic hashes; if each of the copy cryptographic hashes is identical to each of the original cryptographic hashes, reporting full authentication; if each of the copy cryptographic hashes is not identical to each of the original cryptographic hashes: determining whether there is a copy time period during which one of the copy cryptographic hashes is not identical to one of the original cryptographic hashes, and reporting that copy time period; determining whether there is an original time period associated with one of the original cryptographic hashes for which there is no copy cryptographic hash with a copy time period equal to that original time period, and reporting that original time period.

These and other embodiments are contemplated and described herein. It will be appreciated that the foregoing summary sets out representative aspects of systems and methods for secure authentication of live video to assist skilled readers in understanding the following detailed description.

### BRIEF DESCRIPTION OF THE DRAWINGS

A greater understanding of the embodiments will be had with reference to the figures, in which:

FIG. 1 illustrates a block diagram of a system for securely authenticating a live video feed, according to an embodiment.

FIG. 2 illustrates a block diagram of a video chunk, according to an embodiment.

FIG. 3 illustrates a block diagram of an exemplary system for publishing video data chunk hashes, in accordance with the system of FIG. 1.

FIG. 4 illustrates a block diagram of an exemplary system for verifying video data chunk hashes, in accordance with the system of FIG. 1.

FIG. 5 illustrates a flow diagram of a method of creating a verifiable record of live video data chunk cryptographic hashes from a live video feed, according to an embodiment.

FIG. 6 illustrates a flow diagram of a method of securely authenticating a portion of a live video feed, according to an embodiment.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine, or device exemplified herein that executes instructions may include or otherwise have access to computer-readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer-readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application, or module herein described may be implemented using computer readable/executable instructions that may be stored or otherwise held by such computer-readable media and executed by the one or more processors.

Mobile and wearable cameras are generally inadequate for an every-day personal security use case for many reasons, including: not being secure, not being connected, and capturing video that is difficult to validate as real. The latter point is of rising importance as video-doctoring tools and algorithms gain popularity and accessibility. Already, it is entirely reasonable to question the authenticity of any video. This problem may worsen over time as the technology improves.

Embodiments generally provide technological solutions to the aforementioned technical problems. Authenticating live video poses the technical challenge of using a computer or network to reduce or eliminate the possibility that video authenticity may be compromised in copies of the live video. Authenticating live video also poses the technical challenge of using a computer or network to guarantee retrieval of data needed to authenticate the video at a later date in such a manner that provides confidence in the authenticity of the video.

The present disclosure provides systems, methods, and computer programs providing time-independent decentralized authentication of live video that is recorded simultaneously with hashes of metadata being uploaded to a smart contract based blockchain. In general, the disclosed systems, methods, and computer programs provide for secure authentication of live video in near real time by creating context-based (e.g., related to timestamps and/or GPS locations) hashes of video data chunks and storing the hashes on a blockchain. This provides near real-time recording of hashes for captured video to allow a video consumer device to verify whether a copy of the captured video has been manipulated. It will be appreciated that the disclosed systems, methods, and computer programs can equally be applied to the authentication of live audio.

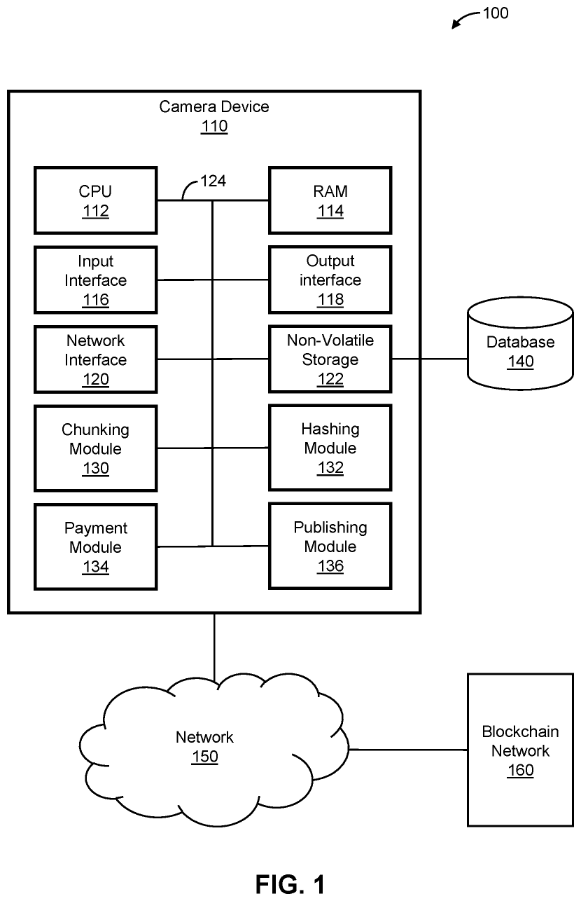

Referring now to FIG. 1, a system for secure authentication of live video 100, in accordance with an embodiment, is shown. The system 100 generally comprises a camera device 110 communicatively linked to a blockchain network 160 by a network 150. Blockchain network 160 may be Ethereum, another smart contract based blockchain, or any other suitable blockchain network. Network 150 may be the Internet, or any other suitable network that provides a connection to blockchain network 160.

FIG. 1 shows various physical and logical components of an embodiment of system 100. As shown, camera device 110 has a number of physical and logical components, including a central processing unit (“CPU”) 112 (comprising one or more processors), random access memory (“RAM”) 114, an input interface 116, an output interface 118, a network interface 120, non-volatile storage 122, and a local bus 124 enabling CPU 112 to communicate with the other components. CPU 112 executes an operating system, and various modules, as described below in greater detail. RAM 114 provides relatively responsive volatile storage to CPU 112. Input interface 116 enables a user to provide input via an input device, such as a camera, microphone, button, keyboard, or touchscreen. Output interface 118 outputs information to output devices, such as a display and/or speakers. In some cases, input interface 116 and output interface 118 can be the same device (e.g., a touchscreen or tablet computer). Network interface 120 permits communication with other systems, such as blockchain network 160 and servers remotely located from the camera device 110, such as for a typical cloud-based storage model. Non-volatile storage 122 stores the operating system and programs, including computer-executable instructions for implementing the operating system and modules, as well as any data used by these services. Additional stored data, as described below, can be stored in a database 140. Database 140 may be local (e.g., coupled to camera device 110). In other embodiments, database 140 may be remote (e.g., accessible via a web server). Data from database 140 may be transferred to non-volatile storage 122 prior to or during operation of the camera device 110. Similarly, data from non-volatile storage 122 may be transferred to database 140. During operation of the camera device 110, the operating system, the modules, and the related data may be retrieved from the non-volatile storage 122 and placed in RAM 114 to facilitate execution. In some embodiments, the camera device 110 further includes a chunking module 130, a hashing module 132, a payment module 134, and/or a publishing module 136. Chunking module 130 may separate a live video feed into video data chunks. Hashing module 132 may calculate a chunk hash for each video data chunk. Payment module 134 may create a payment token for the blockchain network 160. Publishing module 135 may combine the chunk hash, the payment token, a time period identifier, a content UUID, and/or any other suitable data to be used by a smart contract for publishing to the blockchain network 160.

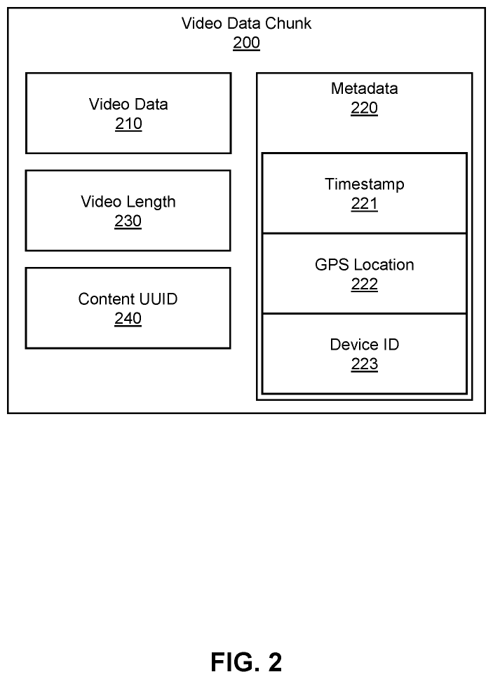

FIG. 2 illustrates a block diagram of a video data chunk 200, in accordance with FIG. 1. Video data chunk 200 may be created by chunking module 130 from the data obtained from a live video feed. Video data chunk 200 may comprise video data 210, metadata 220, a video length 230, and a content UUID 240. The video data 210 is typically the video and sound recorded by camera device 110. Video data 210 may consist of both video and sound, just video, or just sound. The metadata 220 includes, for example, a timestamp 221, a GPS location 222, and a device ID 223. The video length 230 is the length of the video in seconds, milliseconds, frames, or other suitable unit of measurement. The content UUID 240 is the universally unique identifier (UUID) that may be represented by a 128-bit number to identify the video data chunk 200. In a particular case, the UUID 240 can be a version 4 UUID that is randomly generated.

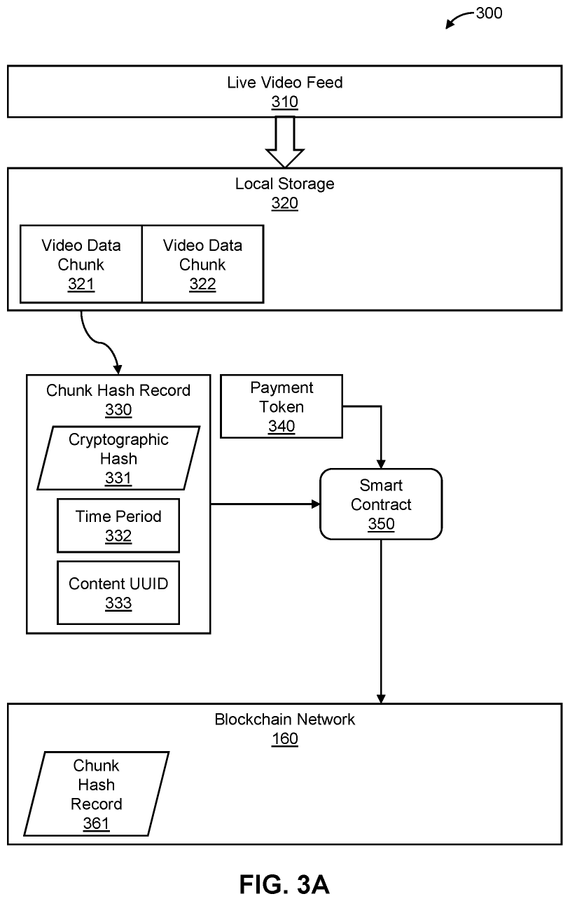

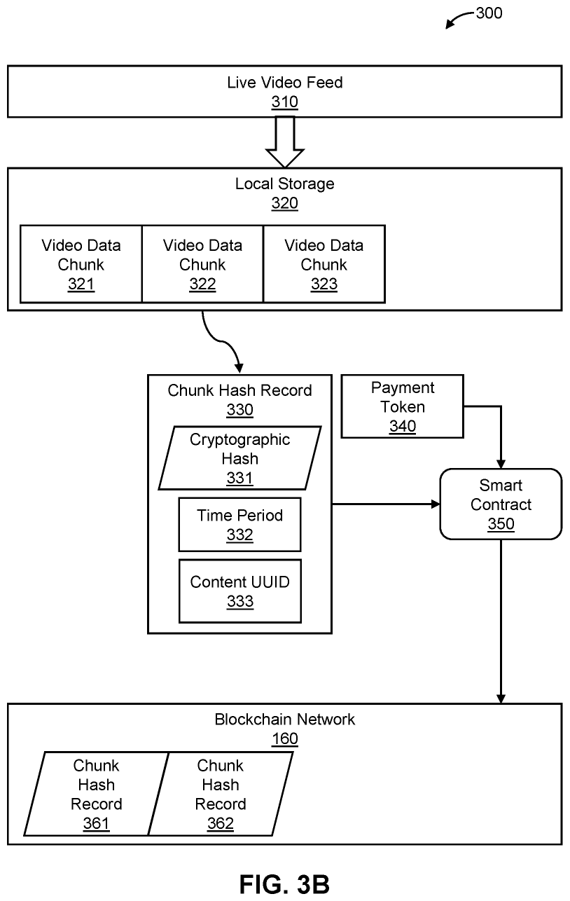

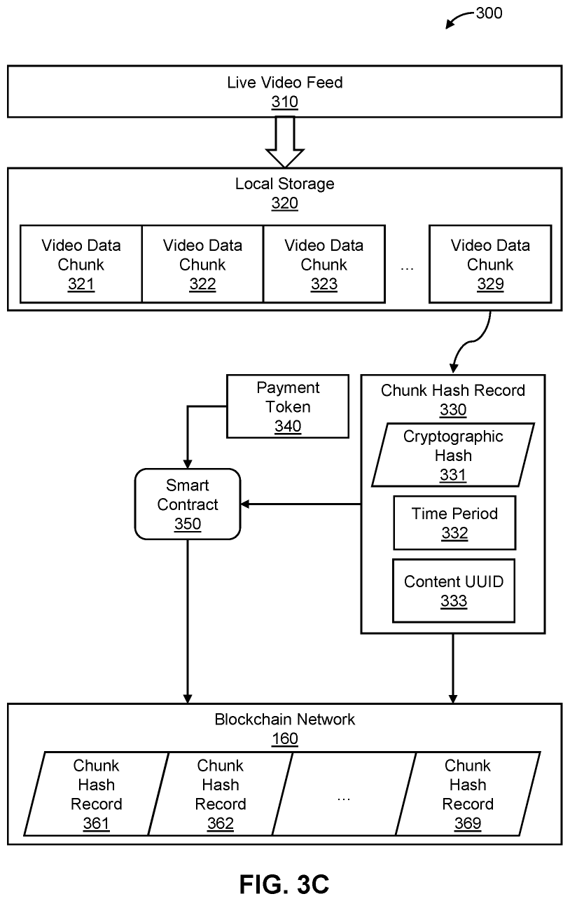

FIGS. 3A to 3C illustrate block diagrams of exemplary data flow while publishing video data chunk hashes 300, in accordance with FIG. 1. More specifically, data flow 300 shows how system 100 creates a verifiable record of live video data chunk cryptographic hashes from a live video feed 310. Camera device 110 generates the live video feed 310. The live video feed 310 is stored in local storage 320. Local storage 320 may be any combination of one or more of RAM 114, non-volatile storage 122, and database 140. Chunking module 130 obtains from live video feed 310 the data required to create video data chunks 321, 322, and so on (if needed) in real time. For example, if chunking module 130 is configured to create video data chunks each having a length of one minute, then chunking module 130 creates video data chunk 321 after camera device 110 has been generating the live video feed 310 for one minute. Chunking module 130 may then create video data chunk 322 for the next minute of the live video feed 310. In general, chunking module 130 may continuously create sequential video data chunks 321, 322, and so on (if needed) from the live video feed 310 every minute during operation of the camera device 110. FIG. 3A provides a snapshot in time when video data chunk 321 has been created and video data chunk 322 is in the process of being created. FIG. 3B provides a snapshot in time when video data chunk 322 has been created and video data chunk 323 is in the process of being created. FIG. 3C provides a snapshot in time when video data chunks 321, 322, and so on through to 329 have all been created. Video data chunk 321 (and further video data chunks if needed) may be comprised of the same data or records as those shown in video data chunk 200 of FIG. 2.

Hashing module 132 creates a chunk hash record 330 for video data chunk 321 (and further video data chunks if needed) in real time. Hashing module 132 can create video data chunks 321 using a hashing algorithm, for example, SHA-256. For example, if chunking module 130 is configured to create video data chunks each having a length of one minute, then hashing module 132 creates chunk hash record 330 within a minute after chunking module 130 has created video data chunk 321. Chunk hash record 330 includes a cryptographic hash 331 that is calculated using both the video data itself and its associated metadata. Chunk hash record 330 may also include a time period record 332 and content UUID 333 associated with video data chunk 321. In this way, chunk hash record 330 is a data structure that can get published along with the smart contract containing the hash of the video 331, the timestamp for which the video has been posted 332, and a unique ID of this data structure record 333. Payment module 134 creates a payment token 340. Publishing module 136 combines chunk hash record 330 and payment token 340 to be input into a smart contract 350. The smart contract 350 sends the chunk hash record 330 and payment token 340 to the blockchain network 160. Payment token 340 pays nodes for storing the chunk hash records for a certain amount of time. FIG. 3A provides a snapshot in time when video data chunk 321 has been created and is used as input by hashing module 132 to create a chunk hash record 330 for the first time. FIG. 3B provides a snapshot in time when video data chunk 322 has been created and is used as input by hashing module 132 to create a chunk hash record 330 for the second time. FIG. 3C provides a snapshot in time when video data chunk 329 has been created and is used as input by hashing module 132 to create a chunk hash record 330 for the ninth time.

In an example, the blockchain network used by the system 100 can be the Ethereum blockchain network. In this example, the system 100 can use the Web3 library to interface with the Ethereum network. In this example, the smart contracts can be ERC-20 compatible. The following presents an example of the creation of a smart contract, in accordance with the present embodiments:

pragma solidity ^{\hat{ }}0.4.0;
contract Validation {

mapping (string => string) video_hashes;
mapping (string => bool) funded_hash;
string video_uuid;
string video_hash
// Event to announce new video hash on the blockchain
event VideoBroadcast(string video_uuid, string video_hash);
function Validation( ) public {
}
// Ensure payment prior to posting validation contracts
function( ) public payable{

if (msg.value > 20000000000000000) {

//if the value sent greater than 0.02 ether (in Wei)
// then allow hashes for this video the posted
funded_hash[video_uuid] = true;

}

}
// Read-only function that returns hashes for video
function getHashForVideo(string _video_uuid) public view returns(string) {

return video_hashes[_video_uuid];

}
//Modify the state on the blockchain
function broadcastVideoHash(string _video_hash) public returns (bool success) {

if (funded_hash[_video_uuid]) {

video_hashes[video_uuid] = _video_hash;
emit VideoBroadcast(video_uuid, video_hash);
return true;

} else {

return false;

}

}}

While the above example uses the Ethereum blockchain network, it is understood that any blockchain network that allows for smart contracts may be used.

The payment token 340 may be required in some cases depending on the requirements of the block chain network. Generally, the purpose of the payment token is to “pay” and “get paid” for storage of the hash record 330e. Without such a token, the system may face a problem with entropy whereby certain published data disappears from the networks because nodes disappear with time or get replaced with new data being published. If a user is relying on data being there to prove authenticity at an undetermined later date, the risk of entropy may invalidate the ability to authenticate.

The video data chunks stay on camera device 110. Alternatively, or in addition, the video data chunks are stored in the cloud. Each time the hashing module 132 creates a chunk hash record 330, the chunk hash record 330 is stored on the blockchain network 160. If needed, this process is repeated for each video data chunk created by chunking module 130. This may result in a series of chunk hash records stored on the blockchain network 160. For the sake of illustration purposes only, FIGS. 3A to 3C show how 9 video data chunks provide the data used to calculate 9 chunk hash records that get stored on the blockchain network 160. In FIG. 3A, smart contract 350 sends the chunk hash record 330 created from video data chunk 321 to the blockchain network 160, resulting in chunk hash record 361 being stored on the blockchain network 160. In FIG. 3B, smart contract 350 sends the chunk hash record 330 created from video data chunk 322 to the blockchain network 160, resulting in chunk hash record 362 being stored on the blockchain network 160. In FIG. 3C, smart contract 350 sends the chunk hash record 330 created from video data chunk 329 to the blockchain network 160, resulting in chunk hash record 369 being stored on the blockchain network 160. Smart contract 350 may send the chunk hash records immediately after they are created. For example, referring to FIG. 3B, smart contract 350 may send the chunk hash record 330 created from video data chunk 322 to the blockchain network 160 while chunking module 130 is creating video data chunk 323.

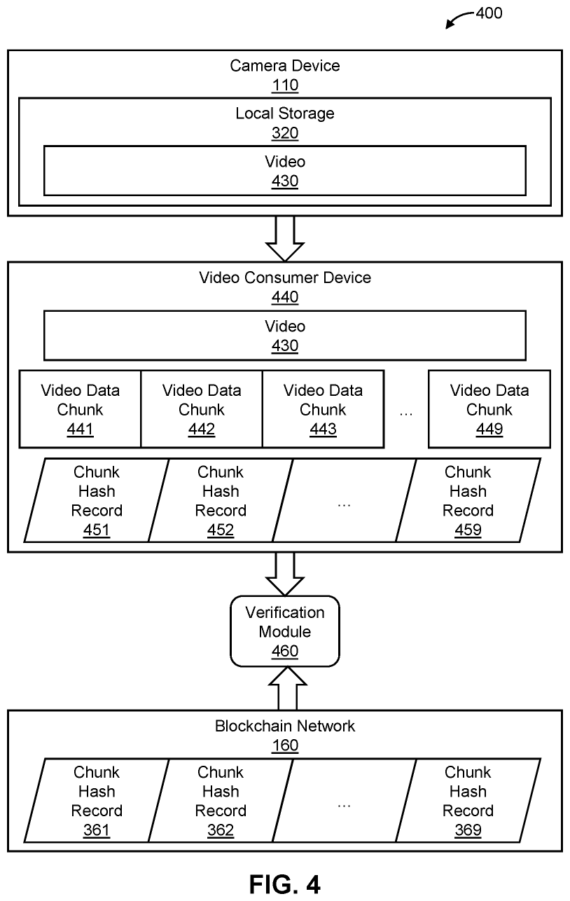

FIG. 4 illustrates a block diagram of exemplary data flow while verifying video data chunk hashes 400, in accordance with FIG. 1. More specifically, data flow 400 shows how a video consumer device 440 verifies a record of live video data chunk cryptographic hashes created by system 100. Camera device 110 has on its local storage 320 a video 430. As in FIG. 3, local storage 320 may be any combination of one or more of RAM 114, non-volatile storage 122, and database 140. Video 430 is the file created by camera device 110 that saves all or a portion of the live video feed 310. Camera device 110 sends video 430 to a video consumer device 440. Video consumer device 440 separates video 430 into video data chunks 441, 442, and so on (if needed). Video consumer device 440 creates a chunk hash record 451 for video data chunk 441 (and further video data chunks if needed). Chunk hash record 451 includes a cryptographic hash (not shown) that is calculated using both the video data itself and its associated metadata. Chunk hash record 330 may also include a time period record (not shown) and content UUID (not shown) associated with video data chunk 441. This may result in a series of chunk hash records stored on video consumer device 440. Video consumer device 440 sends chunk hash record 451 to verification module 460 to compare it with chunk hash record 361 stored on the blockchain network 160. In some cases, the comparison can be a one-to-one comparison of bits. Verification module 460 checks whether the video consumer device's series of chunk hash records lines up exactly with the blockchain network's series of chunk hash records. FIG. 4 shows 9 chunk hash records that video consumer device 440 verifies with the 9 chunk hash records stored on the blockchain network 160.

Verification module 460 may use the following example pseudocode to validate whether the video consumer's series of chunk hash records line up exactly with the blockchain network's series of chunk hash records:

validate(video)
{

hash_frequency = video.read_metadata(“hash_frequency”)
list_of_video_chunks = split(video_file, hash_frequency)
content_id = video.read_metadata(“content_id”)
published_hashes[ ] = retrieve_hashes_from_blockchain(content_id)
if (size(published_hashes) != size(list_of_video_chunks)):

return false

for index, chunk in list_of_video_chunks:

if (hash(chunk) != published_hashes[index]):

return false

return true

}

In the above pseudocode, verification module 460 reads the hashing frequency in the video metadata (i.e., whether the chunks are created every 30 s, 1 minute, etc.). Verification module 460 separates the video files according to the same periodicity that the source separated them. Using an identifier in video metadata, verification module 460 finds the associated hashes stored in blockchain smart contracts. Verification module 460 retrieves the hash values from the blockchain for the content ID that the source would have published them as. Verification module 460 stores the values in a look-up dictionary. If either the video was cut, or sections were edited out, verification module 460 returns false. Verification module 460 iterates over the chunks and validate the hashes. If the hashes do not equal (i.e., the video had been edited since it was first recorded), verification module 460 returns false. If the number of hashes in the recalculated container based on the video source is the same as that of published hashes, and the hash values are all the same, then the video has not been tampered with since it was first recorded, and the video is validated. If the video is validated, verification module 460 returns true.

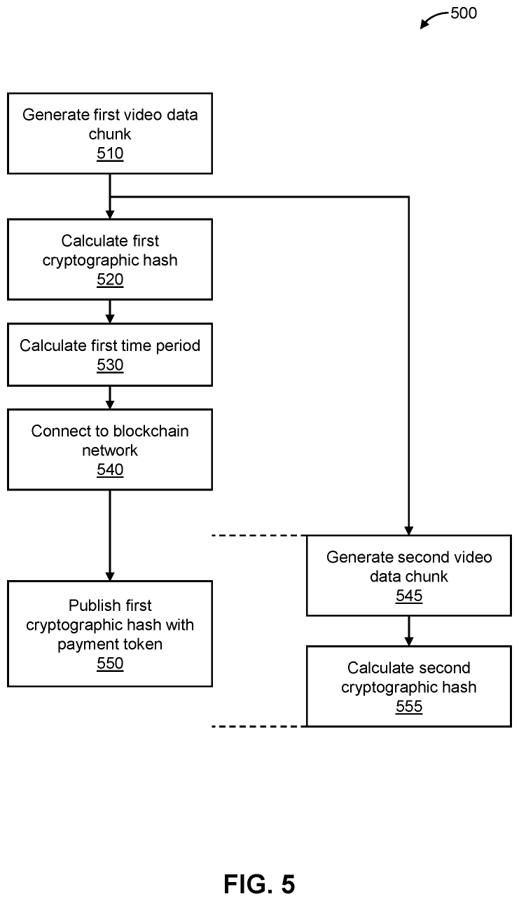

FIG. 5 illustrates a method of creating a verifiable record of live video data chunk cryptographic hashes from a live video feed 500, in accordance with an embodiment. Method 500 may be carried out in such a way as to accomplish some or all of the exemplary data flow illustrated in FIGS. 3A to 3C. At block 510, camera device 110 generates a first video data chunk from the live video feed while recording live video. The first video data chunk may include first video data, a first video length, a first content UUID, and/or first metadata. The first metadata includes, for example, a timestamp, a GPS location, and a device ID. At block 520, camera device 110 calculates a first cryptographic hash of the first video data chunk. At block 530, camera device 110 calculates a first time period for the first video data chunk from the first video length and the first timestamp. At block 540, camera device 110 connects to a blockchain network. At block 545, camera device 110 generates a second video data chunk from the live video feed while recording live video. At block 550, camera device 110 publishes the first cryptographic hash, the first time period, and the first content UUID, along with an associated payment token, to the blockchain network. At block 555, camera device 110 calculates a second cryptographic hash of the second video data chunk.

In some embodiments, the actions described at block 550 may be taken after the actions described at block 545 have started but before the actions described at block 555 have finished. In the embodiment illustrated in FIG. 5, for example, camera device 110 may publish the first cryptographic hash, the first time period, and the first content UUID, along with an associated payment token, to the blockchain network after camera device 110 starts generating a second video data chunk from the live video feed while recording live video but before camera device 110 finishes calculating a second cryptographic hash of the second video data chunk. For illustration purposes, dashed lines are provided to show when the actions described at block 545 have started and when the actions described at block 555 have finished; block 550 is positioned between the dashed lines to assist the reader in visualizing this exemplary timeline. This exemplary timeline may be advantageous in handling a live video feed through the use of concurrent or parallel processing. It will be appreciated that the actions described at block 550 may be taken at different times to accomplish different goals, such as to handle interrupted connections to the blockchain network.

In some embodiments, camera device 110 generates two or more video data chunks from the live video feed at regular intervals (e.g., every minute). Camera device 110 calculates a cryptographic hash of each video data chunk as each is generated. The time period calculated for each video data chunk then shows the beginning and end time of the video data chunk. The camera device 110 may or may not have a continuous connection to the blockchain network. If the connection is continuous, then camera device 110 does not need to reconnect until the camera device has completed recording live video. If the connection is interrupted, camera device 110 reconnects when possible. As each cryptographic hash is calculated, camera device 110 publishes the cryptographic hash, the time period, and the content UUID, along with an associated payment token, to the blockchain network. The camera device 110 may perform the above actions in sequence or in no particular order. Some of the actions may be omitted if not needed or redundant. Some actions may be done simultaneously or in parallel.

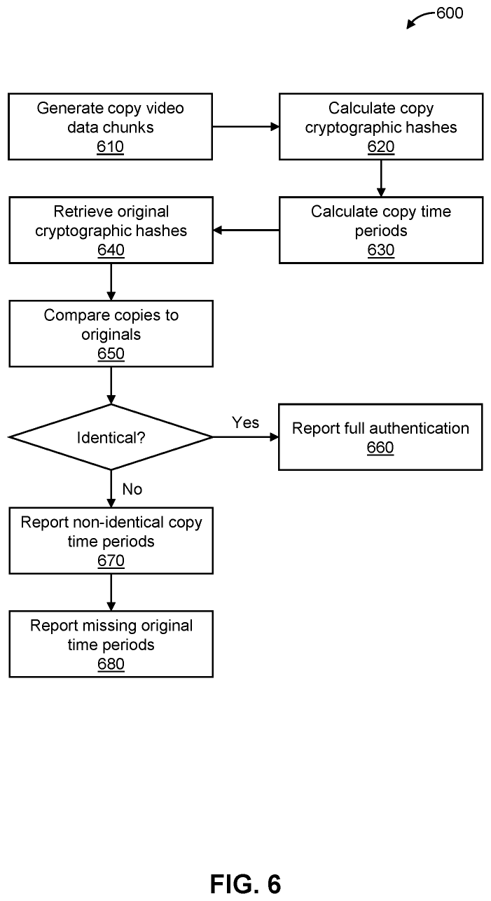

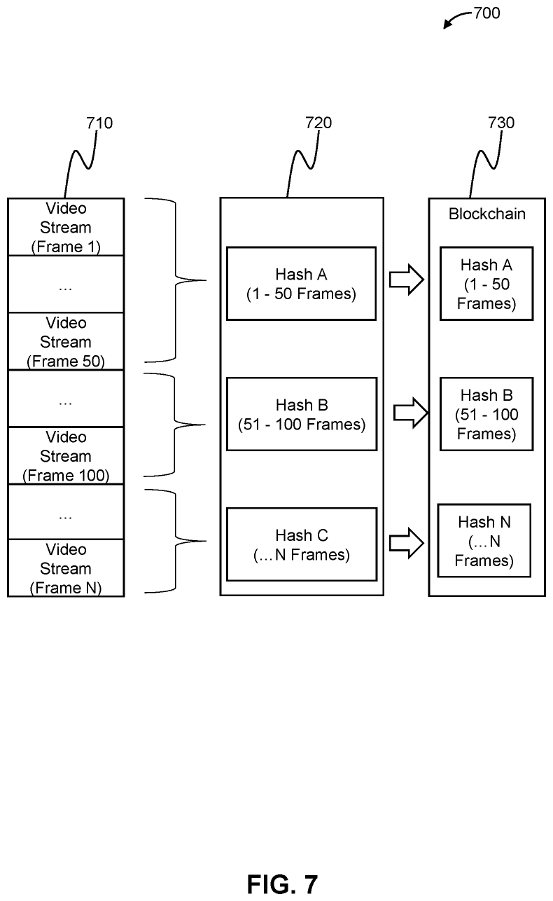

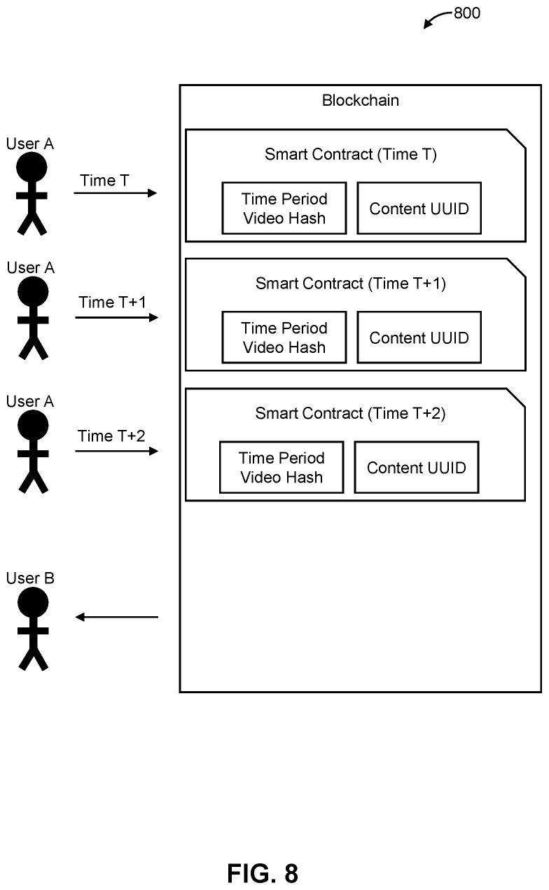

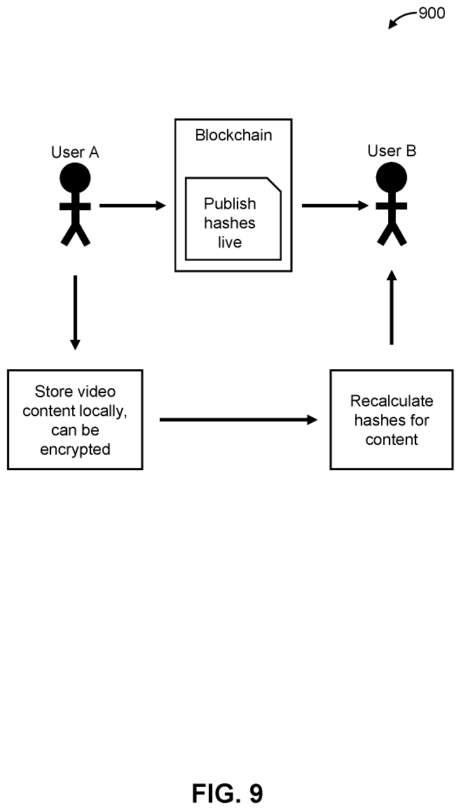

FIG. 6 illustrates a method of securely authenticating a portion of a live video feed 600, in accordance with an embodiment. Method 600 may be carried out in such a way as to accomplish some or all of the exemplary data flow illustrated in FIG. 4. At block 610, video consumer 440 generates copy video data chunks from a copy of the live video feed. The copy video data chunks include copy video data, copy video lengths, and copy timestamps. At block 620, video consumer device 440 calculates copy cryptographic hashes for each of the copy video data chunks. At block 630, video consumer device 440 calculates a copy time period from the copy video length and copy timestamp for each of the copy video data chunks. At block 640, video consumer device 440 retrieves original cryptographic hashes from a blockchain network. At block 650, verification module 460 compares the copy cryptographic hashes with the original cryptographic hashes and records when they are identical to each other. At block 660, verification module 460 reports full authentication if all the copy cryptographic hashes are identical to all the original cryptographic hashes. If not all the copy cryptographic hashes are identical to all the original cryptographic hashes, then verification module 460 reports the discrepancies. At block 670, verification module 460 determines whether there are time periods during which copy cryptographic hashes are not identical to original cryptographic hashes at the same time period and, if so, reports those as non-identical copy time periods (e.g., where copy video data chunks have been altered). At block 680, verification module 460 determines whether there are time periods associated with the original cryptographic hashes during which there are no copy cryptographic hashes and, if so, reports those as missing original time periods (e.g., where copy video data chunks have been removed).

In an example, if video chunks are being generated every 3 minutes and the live video lasts for 9 minutes, the SHA-256 algorithm would produce a consistent hash for an MP4 file that contains unadulterated video and correct timestamps in the metadata on every device that has a SHA-256 library. The hashes would be generated for each of the 3 video chunks (which include timestamps as one of the inputs). The video consumer 440 can then verify that hash with what the corresponding hash on the blockchain. If there is a mismatch, that means the video has been modified (either the time stamps or the video content itself). Thus, allowing for consistent comparison between hashes of the copy and the original video.

FIG. 7 illustrates a block diagram of a sequence of hash publishing 700, in accordance with an embodiment. Camera device 110 records the live video feed 310 as a video stream 710. Camera device 110 breaks down the video stream 710 into N Frames. Chunking module 130 groups the N Frames into groups of 50 frames. Hashing module 132 calculates cryptographic hashes for each group of 50 frames, generating a record of three hashes A, B, and C 720. Publishing module 136 publishes the record 720 onto a blockchain, creating a verifiable record of hashes 730.

FIG. 8 illustrates a block diagram of an example user interaction with a blockchain 800, in accordance with an embodiment. User A operates camera device 110 to capture live video from time period T to T+2. Publishing module 136 publishes hashes for each period to a blockchain. Smart contract 350 records for each time period the information it is programmed to record, such as the time periods themselves, the video hashes, and the content UUIDs. User A then shares a video file of the captured live video with User B. User B reads all hashes for the entire video from the blockchain, recalculating hashes for shared content, and verifying that the hashes match.

FIG. 9 illustrates a flow diagram of an example user interaction with a blockchain 900, in accordance with FIG. 8. User A operates camera device 110 to capture live video, which is stored as video 430. User A creates and owns smart contract 350. Publishing module 136 publishes hashes live on the blockchain network 160. At or around the same time, camera device 110 stores video content locally, which may be encrypted. User A then shares with User B a video file that is part or all of video 430. User B operates video consumer device 440 to recalculate hashes from the video content obtained from User A. Video consumer device 440 reads hashes from the smart contract 350 obtained from the blockchain network 160. Video consumer device 440 then compares the smart contract hashes with the recalculated video content hashes. If the recalculated video content hashes are the same as the smart contract hashes, then the video file that User B obtained from User A has been authenticated. Alternatively, if some of the recalculated video content hashes are not the same as those published on the blockchain network 160, User B is able to identify the specific sections of the video file obtained from User A that have been altered.

In example user interaction 900, the video file that User A shares with User B may have been trimmed to omit a portion of the video 430 (e.g., to prepare for broadcast television, to intentionally distort the facts). In this case, User B can reference the hashes in the blockchain network 160 to identify exactly where the video content obtained from User A may have missing sections and approximately how long those time periods are.

In example user interaction 900, the video file that User A shares with User B may be either all of video 430 or some portion of video 430. In the case that the video file shared is some portion of video 430, the portion can have as little as one video data chunk 441. The video data chunk 441 can be, for example, one minute long. This may be the only part of the video 430 which User B is interested in.

In example user interaction 900, User A may share with User B video 430 as it is being recorded with a short delay (e.g., less than or equal to the length of a video data chunk). In this case, User B can operate video consumer device 440 to recalculate hashes from the video content obtained from User A for each video data chunk 441, 442, and so on (if needed). Video consumer device 440 can read hashes from the smart contract 350 as each hash is made available on the blockchain network 160. In the situation where, for example, the short delay is ten seconds and the length of the video data chunks is also ten seconds, User B can get the equivalent of authenticated streaming video on video consumer device 440.

Although the invention has been described with reference to certain specific embodiments, various modifications thereof will be apparent to those skilled in the art without departing from the spirit and scope of the invention as outlined in the claims appended hereto.

1. A computer-implemented method for generating authenticatable data for a live video for publication on a block chain network, the method comprising:
for each successive portion of the live video, each successive portion having an associated length and timestamp, generating the authentication by iteratively performing:
generating a video chunk comprising the portion of the live video having the associated video length and timestamp;
determining a cryptographic hash of the video chunk;
determining a time period from the associated video length and timestamp; and
publishing the cryptographic hash and the respective time period to the block chain network.

2. The method of claim 1, wherein each successive portion is at a regular interval of time.

3. The method of claim 1, wherein the cryptographic hash and the respective time period are published to the blockchain network prior to completion of the determination of the cryptographic hash of the succeeding video portion.

4. The method of claim 1, further comprising authenticating the copy of the live video, comprising:
for each successive portion of the copy of the live video, iteratively performing:
generating a copy video chunk of the copy of the live video having an associated copy video length and copy timestamp;
determining a copy time period from the associated copy video length and copy timestamp;
determining a copy cryptographic hash of the copy of the live video;
receiving the cryptographic hash; and
comparing the cryptographic hash to the copy cryptographic hash; and
outputting each of the comparisons for authentication.

5. The method of claim 4, wherein publishing the cryptographic hash and the respective time period to the block chain network comprises associating a unique identifier with each publication; and wherein receiving the cryptographic hash comprises locating the cryptographic hash associated with the copy cryptographic hash using the unique identifier.

6. The method of claim 4, wherein the output of the comparisons comprises outputting full authentication if all the copy cryptographic hashes are identical to the associated cryptographic hashes, and outputting discrepancies for any copy cryptographic hash not identical to the associated cryptographic hash.

7. The method of claim 6, wherein if each of the copy cryptographic hashes is not identical to each of the cryptographic hashes, outputting the copy time periods during which copy cryptographic hashes are not identical to the associated cryptographic hashes at the associated time period.

8. The method of claim 4, wherein for each successive cryptographic hash and respective time period on the block chain, the iteratively performing further comprises determining whether there are time periods associated with the cryptographic hashes during which there are no copy cryptographic hashes, and the method further comprising outputting such time periods.

9. The method of claim 1, wherein publishing the cryptographic hash and the respective time period to the block chain network comprises a smart contract, the smart contract comprises providing a chunk hash record and a payment token to the blockchain network.

10. The method of claim 9, wherein the smart contract further comprises a universally unique identifier (UUID) to identify each video data chunk.

11. A system for generating authenticatable data for a live video for publication on a block chain network, the system comprising one or more processors and a data storage, for each successive portion of the live video, each successive portion having an associated length and timestamp, the one or more processors generate the authentication by iteratively executing:
a chunking module to generate a video chunk comprising the portion of the live video having the associated video length and timestamp;
a hashing module to determine a cryptographic hash of the video chunk and to determine a time period from the associated video length and timestamp; and
a publishing module to publish the cryptographic hash and the respective time period to the block chain network.

12. The system of claim 11, wherein each successive portion is at a regular interval of time.

13. The system of claim 11, wherein the cryptographic hash and the respective time period are published to the blockchain network by the publishing module prior to completion of the determination of the cryptographic hash of the succeeding video portion by the hashing module.

14. The system of claim 11, for each successive portion of the copy of the live video, wherein one or more processors on a separate computing device authenticates the copy of the live video by further executing a verification module that iteratively performs:
generating a copy video chunk of the copy of the live video having an associated copy video length and copy timestamp;
determining a copy time period from the associated copy video length and copy timestamp;
determining a copy cryptographic hash of the copy of the live video;
receiving the cryptographic hash; and
comparing the cryptographic hash to the copy cryptographic hash; and
outputting the comparison for authentication.

15. The system of claim 14, wherein publishing the cryptographic hash and the respective time period to the block chain network comprises associating a unique identifier with each publication; and wherein receiving the cryptographic hash comprises locating the cryptographic hash associated with the copy cryptographic hash using the unique identifier.

16. The system of claim 14, wherein the output of the comparisons comprises outputting full authentication if all the copy cryptographic hashes are identical to the associated cryptographic hashes, and outputting discrepancies for any copy cryptographic hash not identical to the associated cryptographic hash.

17. The system of claim 16, wherein if each of the copy cryptographic hashes is not identical to each of the cryptographic hashes, outputting the copy time periods during which copy cryptographic hashes are not identical to the associated cryptographic hashes at the associated time period.

18. The system of claim 14, wherein for each successive cryptographic hash and respective time period on the block chain, the iteratively performing further comprises determining whether there are time periods associated with the cryptographic hashes during which there are no copy cryptographic hashes, and the method further comprising outputting such time periods.

19. The system of claim 11, wherein publishing the cryptographic hash and the respective time period to the block chain network by the publishing module comprises a smart contract, the smart contract comprises providing a chunk hash record and a payment token to the blockchain network.

20. The system of claim 19, wherein the smart contract further comprises a universally unique identifier (UUID) to identify each video data chunk.
